(19) United States
(12) Patent Application Publication
(10) Pub. No.: US 2023/0032272 A1
(43) Pub. Date: Feb. 2, 2023

(54) 3D STRUCTURES TO PROTECT 3D OBJECTS

(71) Applicant: HEWLETT-PACKARD DEVELOPMENT COMPANY, L.P., Spring, TX (US)

(72) Inventors: Pol LLOPART MIRAMBELL, Sant Cugat del Valles (ES); Marta GONZALEZ MALLO, Sant Cugat del Valles (ES); Marc GARCIA GRAU, Sant Cugat del Valles (ES)

(21) Appl. No.: 17/389,229

(22) Filed: Jul. 29, 2021

(51) Int. Cl. B29C 64/393; B29C 64/165; B22F 10/14; B22F 10/85; B33Y 10/00; B33Y 30/00; B33Y 50/02

(52) U.S. Cl. CPC B29C 64/393; B29C 64/165; B22F 10/14; B22F 10/85; B33Y 10/00; B33Y 30/00; B33Y 50/02

(57) ABSTRACT

A computing device comprising a processor is disclosed herein. The processor is to access print data of a virtual build volume including a plurality of 3D objects to be generated through a selective application of a binder agent by a 3D printer. The processor is further to modify the print data to include a 3D structure at a location within the build volume to protect a 3D object from migrating solvents of the binder agent during a curing operation.

### BACKGROUND

Some additive manufacturing or three-dimensional printing systems generate 3D objects by selectively solidifying portions of a successively formed layers of build material on a layer-by-layer basis. The build material which has not been solidified is separated from the 3D objects.

### BRIEF DESCRIPTION OF THE DRAWINGS

The present application may be more fully appreciated in connection with the following detailed description of non-limiting examples taken in conjunction with the accompanying drawings, in which like reference characters refer to like parts throughout and in which:

FIG. 1 is a schematic diagram showing an example of a computing system to modify print data to include a 3D structure;

FIG. 2A is a flowchart of an example method of modifying print data to include a 3D structure;

FIG. 2B is a flowchart of an example method to cure a build volume including a 3D structure;

FIG. 3 illustrates schematically an example curing station comprising a build volume including a 3D structure;

FIGS. 4A-4C illustrate examples of a 3D structure;

FIG. 5A is a flowchart of an example method to modify print data to include a plurality of 3D structures;

FIG. 5B is an example of a build volume including a plurality of 3D structures; and

FIG. 6 is a block diagram showing a processor-based system example of a system to modify print data to include a 3D structure.

### DETAILED DESCRIPTION

The following description is directed to various examples of additive manufacturing, or three-dimensional printing, apparatus and processes involved in the generation of 3D objects. Throughout the present disclosure, the terms “a” and “an” are intended to denote at least one of a particular element. In addition, as used herein, the term “includes” means includes but not limited to, the term “including” means including but not limited to. The term “based on” means based at least in part on.

As used herein, the terms “about” and “substantially” are used to provide flexibility to a range endpoint by providing that a given value may be, for example, an additional 15% more or an additional 15% less than the endpoints of the range. In another example, the range endpoint may be an additional 30% more or an additional 30% less than the endpoints of the range. The degree of flexibility of this term can be dictated by the particular variable.

For simplicity, it is to be understood that in the present disclosure, elements with the same reference numerals in different figures may be structurally the same and may perform the same or similar functionality.

3D printers generate 3D objects based on data in a 3D model of an object or objects to be generated, for example, using a CAD computer program product. This data may be pre-processed by a computing system in a suitable format for the 3D printer. In some examples, the pre-processing may include arranging models of the 3D objects to be generated in a virtual build volume corresponding to the physical build volume in which the 3D objects are to be generated, for example the build volume of a 3D printer. A print job, or other print data, describing the arrangement of 3D objects models within the virtual build volume may be sent to the 3D printer to cause the printer to generate the 3D objects.

3D printers may generate 3D objects by selectively processing layers of build material. For example, a 3D printer may selectively treat portions of a layer of build material, e.g. a powder, corresponding to a slice of 3D object to be generated, thereby leaving the portions of the layer un-treated in the areas where no 3D object is to be generated. The combination of the generated 3D objects and the un-treated build material may also be referred to as build volume. The volume in which the build volume is generated may be referred to as a build volume.

Suitable powder-based build materials for use in additive manufacturing include polymer powder (e.g., Nylon, PA11, PA12, thermoplastic polyurethane, thermoplastic polyamide, polypropylene, etc.), metal powder (e.g., stainless steel) or ceramic powder. In some examples, non-powdered build materials may be used such as gels, pastes, and slurries.

Some 3D printers may selectively treat portions of a layer of build material by ejecting a printing fluid in a pattern corresponding to the 3D object and then apply energy to the layer. 3D printers may apply energy to the build material layer, using for example, an energy source. Examples of printing fluids may include fusing agents, detailing agents, curable binder agents or any printing fluid suitable for the generation of a 3D object.

Some of the above referred agents need to be cured after printing. In the examples herein, a curing process may be understood as raising the temperature of a build volume such that a chemical reaction (e.g., polymerization) or a physical action (e.g., evaporation) takes place, resulting in a harder, tougher or more stable linkage of the particles in which the agent was ejected thereto. In an example, when using a thermally curable binder agent, after the printing process, the particles are attached to each other in a weak bound forming the so-called green parts. This bound is strengthened upon exposing such green parts to curing conditions. After the curing operation, the build volume may be allowed to cool down so that the 3D objects may be separated from the un-solidified build material.

During the curing operation, some solvents of the agent (e.g., binder agent) are separated from the green part and migrate towards an end of the build volume. Through the migration, the solvents may reach and merge with other of the generated 3D objects. The combination of the agent solvent of the other 3D objects and the migrating solvents makes these other 3D objects to comprise an excess amount of solvents which lead to part quality defects (e.g., dimensional accuracy defects) and a reduction of the mechanical properties of the 3D objects.

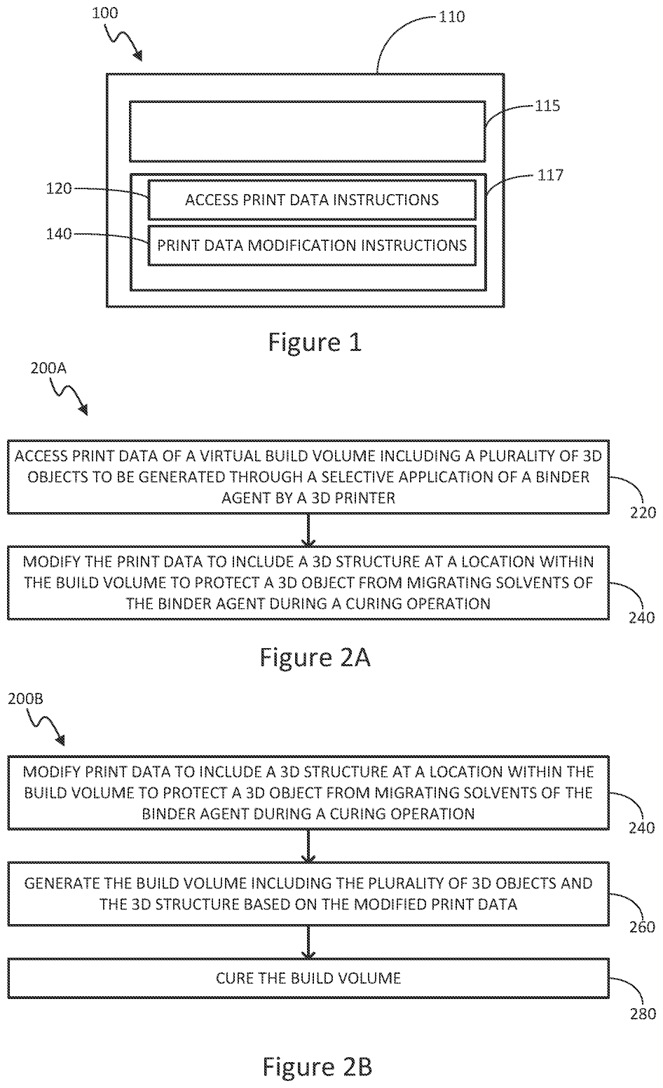

Referring now to the drawings, FIG. 1 is schematic diagram showing an example of a computing system 100. The computing system 100 may be an integral part of a 3D printer or an external system from the 3D printer that may interact with the 3D printer, for example an external computing unit suitable for sending data to the 3D printer.

The computing system 100 comprises a controller 110. The controller 110 comprises a processor 115 and a memory 117 with specific control instructions 120-140 to be executed by the processor 115. The functionality of the controller 110 is described further below with reference to FIG. 2.

In the examples herein, the controller 110 may be any combination of hardware and programming that may be implemented in a number of different ways. For example, the programming of modules may be processor-executable instructions stored in at least one non-transitory machine-readable storage medium and the hardware for modules may include at least one processor to execute those instructions. In some examples described herein, multiple modules may be collectively implemented by a combination of hardware and programming. In other examples, the functionalities of the controller 110 may be, at least partially, implemented in the form of an electronic circuitry. The controller 110 may be a distributed controller, a plurality of controllers, and the like. In the examples herein, 3D print data is modified to include a 3D structure to protect a 3D object from migrating solvents of the binder agent during a curing operation.

FIG. 2A is a flowchart of an example method 200A of modifying print data to include a 3D structure. The blocks 220-240 from method 200A correspond to the instructions 120-140 from FIG. 1 respectively, instructions of which when executed, cause the processor 115 of the controller 110 to perform the method 200A of FIG. 2A.

At block 220, the controller 110 accesses print data of a virtual build volume including a plurality of 3D objects to be generated through a selective application of a binder agent by a 3D printer. The virtual build volume defines the arrangement of the corresponding 3D object models with respect the overall build volume which is to be generated by the 3D printer. The arrangement comprises the position and orientation of the 3D object models within the virtual build volume. In some examples, the controller 110 may receive independent data sets corresponding to the plurality of 3D objects to be generated and may compute the arrangement of the corresponding plurality of 3D object models in the virtual build volume.

In one example, the binder agent can include a binder in a liquid carrier or vehicle for application to the particulate build material. For example, the binder can be present in the binding agent at from about 1 wt % to about 50 wt %, from about 2 wt % to about 30 wt %, from about 5 wt % to about 25 wt %, from about 10 wt % to about 20 wt %, from about 7.5 wt % to about 15 wt %, from about 15 wt % to about 30 wt %, from about 20 wt % to about 30 wt %, or from about 2 wt % to about 12 wt % in the binding agent.

In one example, the binder can include polymer particles, such as latex polymer particles. The polymer particles can have an average particle size that can range from about 100 nm to about 1 μm. In other examples, the polymer particles can have an average particle size that can range from about 150 nm to about 300 nm, from about 200 nm to about 500 nm, or from about 250 nm to 750 nm.

It is noted that once the print data of the virtual build volume is sent to the 3D printer, the printer is to selectively eject the binder agent in successive build material layers. Once the physical build volume comprising the plurality of 3D objects is generated, it is then cured. As already discussed herein, during the curing process, solvents of the binder agent migrate leading to part quality defects and a reduction of the mechanical properties of the 3D objects that the solvents migrate to.

To that end, at block 240, the controller 110 is to modify the print data to include a 3D structure at a location within the build volume. In some examples, the 3D structure is a sacrificial 3D element which is discarded after the powder removal operation. It has been found that the solvent flow inside printed parts, such as the 3D structure, is almost negligible. Therefore, once generated, the 3D structure protects the 3D object from migrating solvents of the binder during the curing operation as the binders are not to traverse the 3D structure. In turn, the solvent flow is to bypass and surround the 3D structure and thereby the 3D structure inhibits the solvent flow from reaching the 3D object.

The 3D structure may comprise any geometry suitable to block the binder solvents migration flow from reaching the 3D objects. Some examples of 3D structures are shown with reference to FIGS. 4A-C.

FIG. 2B is a flowchart of an example method 200B to cure a build volume including a 3D structure. In some examples, method 200B may be executed after method 200A from FIG. 2A. Block 240 from method 200B is the same as or similar to block 240 from method 200A. The blocks 260-280 from method 200B may correspond to further instructions from FIG. 1 (not shown), instructions of which when executed, cause the processor 115 of the controller 110 to perform the method 200B of FIG. 2B.

After block 240, the controller 110 sends the modified print data to a 3D printer. At block 260, the 3D printer is to generate the build volume including the plurality of 3D objects and the 3D structure based on the modified print data. As such, the 3D printer is to successively generate layers of build material and selectively eject the binder agent in each of the layers based on the modified print data. In some examples, the 3D printer may not eject binder agent in a given build material layer or a given set of build material layers.

In some examples, the 3D structure is generated through the ejection of a binder agent or a permeability modifier agent to the corresponding layers of build material. In some examples, the permeability modifier agent may include water and/or an alcohol, such as ethanol. The agent used may be the same agent or a different agent than the binder agent used in the generation of the plurality of 3D objects. Additionally, or alternatively, the 3D printer is to generate the 3D objects and the 3D structure using different print modes. As an example, the 3D printer may generate the 3D objects using a standard print mode and the 3D structure using a draft or fast print mode, thereby providing with a cheaper and faster generation of the build volume.

Once the build volume including the plurality of 3D objects and the 3D structures has been generated by the 3D printer, the build volume is transferred to a curing station. In some examples, the curing station may be in the 3D printer (e.g., in the same build chamber as the 3D objects have been generated). In other examples, however, the curing station is located away from the 3D printer. In the curing station, the build volume is cured (block 280) by heating it to a temperature such that the solvents from the binder agents are removed. As discussed herein, during the solvent removal, the solvents migrate towards an end of the curing station, migration of which may cause part quality defects and a reduction of the mechanical properties of the 3D objects that the solvents migrate to.

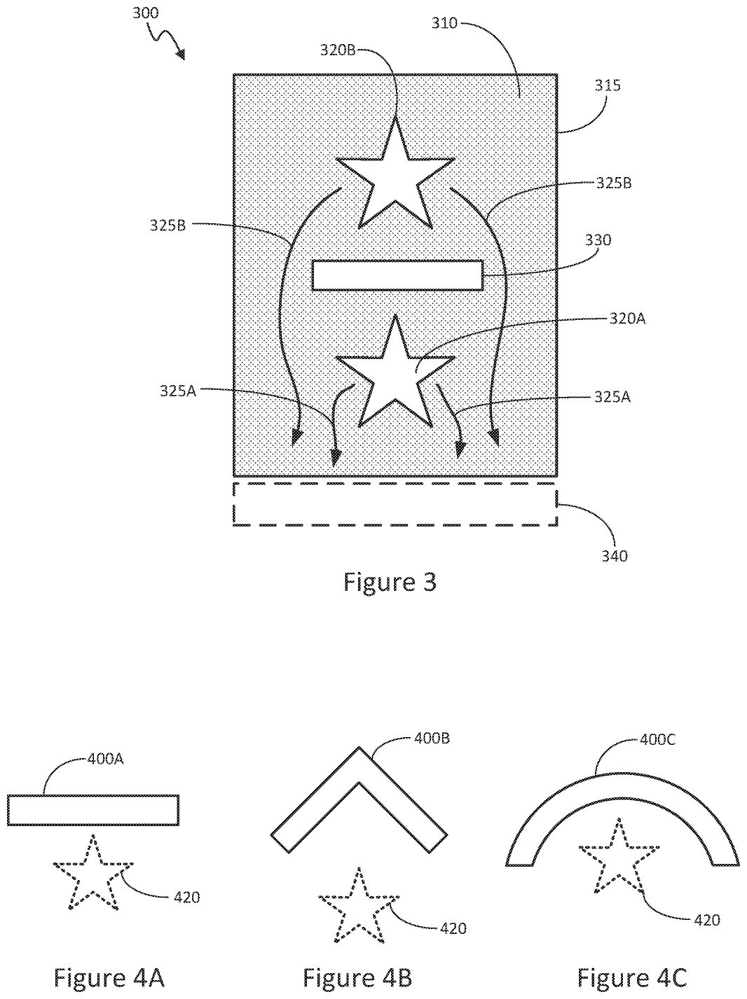

FIG. 3 illustrates schematically an example curing station 300 comprising a build volume 310 including a 3D structure 330. In an example, the illustrated build volume 310 may correspond to the build volume generated in block 260 from FIG. 2B which, in turn, is based on the print data modification of blocks 240 from FIGS. 2A and 2B.

The curing station 300 comprises a build volume enclosure 315 to receive the build volume 310 generated in the 3D printer. The curing station further comprises a set of heating elements (not shown) controllable to heat, and thereby cure, the contents of the build volume enclosure 315 (e.g., the build volume 310).

The curing station 300 comprises a solvent flow generator 340. The solvent flow generator 340 is to generate an airflow within the build volume 310 such that, during the curing operation, the solvents of the binder agent used in the generation of the 3D objects migrate towards the direction induced by the solvent flow generator 340. In some examples, the solvent flow generator 340 is placed at the top of the build volume enclosure 315. In other examples, the solvent flow generator 340 is placed at the bottom of the build volume enclosure 315. In yet other examples, the solvent flow generator 340 is placed at a side of the build volume enclosure 315, e.g., at a lateral wall. In an example, the solvent flow generator 340 is a fan, thereby causing the solvents to flow to the opposite direction as the solvent flow generator 340. In another example, however, the solvent flow generator 340 is a pump, thereby causing the solvents to flow towards the solvent flow generator 340.

The build volume 310 includes a plurality of build material layers which comprise a first 3D object 320A and a second 3D object 320B which have been generated though the selective ejection of a binder agent. In the illustrated example, the first and second 3D objects 320A-B are star-shaped. It is to be understood that the first and second 3D objects 320A-B may have any shape and may be different. This is applicable to the other examples of the present disclosure.

As mentioned above with reference to FIGS. 2A and 2B, the controller 110 is to modify the print data to include a 3D structure 330 at a location within the build volume. In some examples, as the example of FIG. 3, the processor 115 is to modify the print data to include the 3D structure 330 to be vertically coinciding and span substantially the full horizontal section of a 3D object from the plurality of 3D objects, e.g., the second 3D object 320B. Additionally, in an example, the processor 115 is to modify the print data to include the 3D structure 330 between the solvent flow generator 340 and a 3D object, e.g., the first 3D object 320A. That way, the solvent flow generated from curing the first 3D object 320A (i.e., first 3D object solvent flow 325A) is to migrate towards the solvent flow generator 340 without further 3D object interception. Likewise, the solvent flow generated from curing the second 3D object 320B (i.e., second 3D object solvent flow 325B) is to migrate towards the solvent flow generator 340 being blocked by the 3D structure 330, thereby inhibiting the second 3D object solvent flow 325B to reach the first 3D object 320A and not influencing in the first 3D object 320A part quality and mechanical properties.

FIGS. 4A-4C illustrate examples of 3D structures 400A-C respectively. The 3D structure may be the same 3D structure of the examples from FIGS. 1, 2A-B and 3; for example, the 3D structure 330.

As mentioned in some examples above, the 3D structure 400A-C is generated through the selective ejection of a binder agent or a permeability modifier agent. The permeability agent may include water and/or an alcohol, such as ethanol. In some examples, the volume of the 3D structure 400A-C is fully treated with the selected agent. In other examples, however, the volume of the 3D structure 400A-C is partially treated with the selected agent. In one of these examples, the outer shell of the 3D structure 400A-C is treated leaving the inner volume un-treated. In another of these examples, the volume of the 3D structure 400A-C is generated as a lattice structure, thereby leaving sub-volumes of the 3D structure 400A-C un-treated from the ejected agent.

FIG. 4A shows an example of the 3D structure 400A in which the 3D structure 400A is substantially vertically coinciding and spans the full horizontal section of the 3D object 420. In some examples, the 3D structure may span 80% or more than the horizontal section of the 3D object 420. In other examples, the 3D structure 400A may span a larger surface than the horizontal section of the 3D object 420. In some examples, the 3D structure 400A may have a constant vertical cross-section, such as a roof. As such, in some of these examples, any given build material layer comprises a portion the 3D structure 400A and a portion of a 3D object 420, thereby different print modes per build material layer may be used (e.g., draft print mode for the build material layers comprising the 3D structure 400A; and standard print mode for the build material layers comprising the 3D object 420).

FIG. 4B shows another example of a 3D structure 400B in which the 3D structure 400B geometry comprises a concave portion facing the 3D object 420 that the 3D structure 400B is intended to shield from solvents. In an example, the 3D structure 400B comprises a U-shape (e.g., umbrella-shape), inversed U-shape, V-shape or inversed V-shape based on the intended direction of the solvent flow.

FIG. 4C shows another example of a 3D structure 400C in which the 3D structure 400C is to at least partially encapsulate the 3D object 420. In the example, some build material layers comprise both a portion of the 3D structure 400C and a portion of the 3D object 420. The 3D structure 400C is to shield the 3D object 420 from the solvent flow and any potential solvent reflow towards the object. In the examples herein, a reflow should be interpreted as a direction modification of the solvent flow towards the 3D object 420 that may lead to the solvent flow reaching the 3D object 420 (e.g., from a lateral side of the 3D object 420).

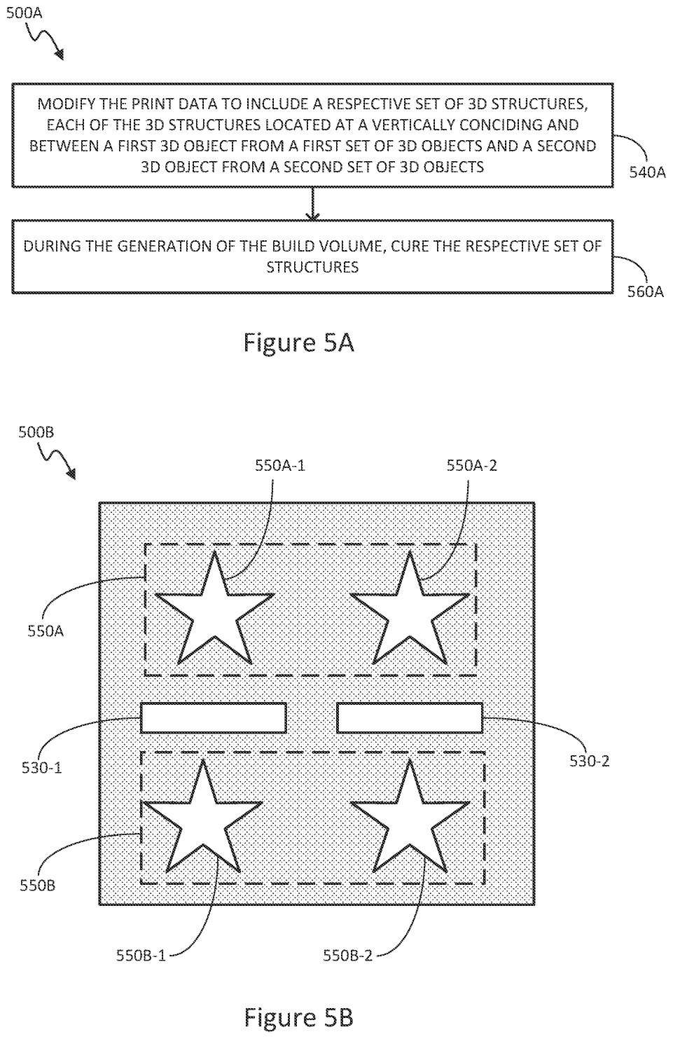

FIG. 5A is a flowchart of an example method 500A to modify print data to include a plurality of 3D structures. In some examples, method 500A may be executed after method 200A from FIG. 2A. Block 540A from method 500A is similar to block 240 from method 200A. Blocks 540A-560A from method 500B may correspond to further instructions from FIG. 1 (not shown), instructions of which when executed, cause the processor 115 of the controller 110 to perform the method 500A of FIG. 2B.

In some examples, the controller 110 may receive a plurality of digital models corresponding to the 3D objects to be generated. The controller 110 may then generate a virtual build volume including the plurality of digital models of the 3D objects at an arrangement. With respect to an arrangement example, a first set of the plurality of 3D objects may be stacked on a respective second set of the plurality of 3D objects. In some other examples, the controller 110 may receive print data including the virtual build volume with the plurality of 3D objects digital model already set at the arrangement.

At block 540A, the controller 110 is to modify the print data to include a respective set of 3D structures which in some instances includes a single 3D structure or a plurality of 3D structures. The 3D structures may be any of the 3D structures disclosed herein, for example the 3D structures 400A-C from FIGS. 4A-4C. The controller 110 is to locate each of the set of 3D structures at a vertically coinciding position with each other (e.g., at the same horizontal planes). In some examples, the 3D structures are located at horizontally coinciding locations apart from any portion of a 3D object to enable a further build material layer-by-layer curing during the printing operation. This provides an increased permeability and recyclability of the build material. The controller 110 is to further locate at least one of the set of the 3D structures between a first 3D object from the first set of 3D objects and a second 3D object from the second set of 3D objects (see, e.g., FIG. 5B for such arrangement). As mentioned above, in some examples, the first set of 3D objects is stacked on the second set of 3D objects.

At block 560A, the controller 110 is to cure the respective set of 3D structures during the generation of the build volume. In some examples, the controller 110 is to cure the 3D structure by controlling a set of energy sources, such as heating elements or UV light sources. In that way, at the end of the printing operation, the build volume includes a plurality of un-cured 3D objects and a set of cured 3D structures. By curing the 3D structures during the printing operation, the migrating solvents generated therefrom do not interfere with any 3D objects. Furthermore, once in the curing station, the cured 3D structures provide an enhanced shield to the migrating solvents flows (see, e.g., flows 325A-B from FIG. 3) thereby inhibiting them to reach the 3D objects and affect its part quality and mechanical properties.

FIG. 5B is an example of a build volume 500B including a plurality of 3D structures. In some examples, the build volume 500B is a representation of the generation of the modified print data of block 540A from FIG. 5A.

The build volume 500B includes a first set of 3D objects 550A vertically stacked on a second set of 3D objects 550B. In the example, the first set of 3D objects 550A includes a plurality of 3D objects (e.g., a first 3D object 550A-1 and a second 3D object 550A-2 of the first set of 3D objects 550A). In the example, the second set of 3D objects 550B includes a plurality of 3D objects (e.g., a first 3D object 550B-1 and a second 3D object 550B-2 of the second set of 3D objects 550B). It is to be noted that the first and second sets of 3D objects 550A-B may include a single 3D object or may further include additional 3D objects, such as 3, 5, or 10 3D objects. It is further to be noted that, in some examples, the number of 3D objects of the first set of 3D objects 550A may be different than the number of 3D objects of the second set of 3D objects 550B.

The build volume 550B further includes a set of 3D structures (530-1, 530-2) between the first set of 3D objects 550A and the second set of 3D objects 550B. In some examples, the set of 3D structures (530-1, 530-2) are at horizontally coinciding locations apart from any portion of a 3D object. As such, a set of empty build material layers between the set of 3D structures (530-1, 530-2) and the first and second sets of 3D objects 550A-B have been generated. In the example, a first 3D structure 530-1 is located substantially vertically coinciding and between the first 3D object 550A-1 of the first set of 3D objects 550A and the first 3D object 550B-1 of the second set of 3D objects 550B. In the example, a second 3D structure 530-2 is located substantially vertically coinciding and between the second 3D object 550A-2 of the first set of 3D objects 550A and the second 3D object 550B-2 of the second set of 3D objects 550B. It is to be noted, however, that in additional examples, a single 3D structure spanning the combined length of the set of 3D structures (530-1, 530-2) could have been used instead. As mentioned above the 3D structures may be any of the 3D structures disclosed herein, for example 3D structures 400A-C from FIGS. 4A-C.

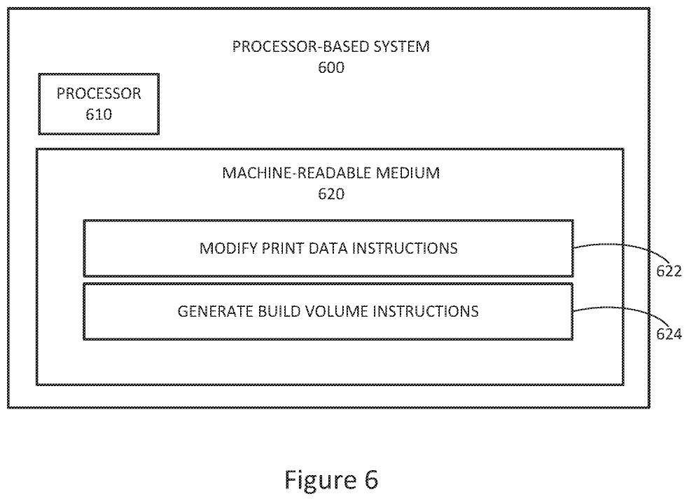

FIG. 6 is a block diagram showing a processor-based system example of a system to modify print data to include a 3D structure. In some implementations, the system 600 may be or may form part of a computing system and/or a 3D printing system, such as a 3D printer. In some implementations, the system 600 is a processor-based system and may include a processor 610 coupled to a machine-readable medium 620. The processor 610 may include a single-core processor, a multi-core processor, an application-specific integrated circuit (ASIC), a field programmable gate array (FPGA), and/or any other hardware device suitable for retrieval and/or execution of instructions from the machine-readable medium 620 (e.g., instructions 622-624) to perform functions related to various examples. Additionally, or alternatively, the processor 610 may include electronic circuitry for performing the functionality described herein, including the functionality of instructions 622-624. With respect of the executable instructions represented as boxes in FIG. 6, it should be understood that part or all of the executable instructions and/or electronic circuits included within one box may, in alternative implementations, be included in a different box shown in the figures or in a different box not shown.

The machine-readable medium 620 may be any medium suitable for storing executable instructions, such as a random-access memory (RAM), electrically erasable programmable read-only memory (EEPROM), flash memory, hard disk drives, optical disks, and the like. In some example implementations, the machine-readable medium 620 may be a tangible, non-transitory medium, where the term “non-transitory” does not encompass transitory propagating signals. The machine-readable medium 620 may be disposed within the processor-based system 600, as shown in FIG. 6, in which case the executable instructions may be deemed “installed” on the system 600. Alternatively, the machine-readable medium 620 may be a portable (e.g., external) storage medium, for example, that allows system 600 to remotely execute the instructions or download the instructions from the storage medium. In this case, the executable instructions may be part of an “installation package”. As described further herein below, the machine-readable medium may be encoded with a set of executable instructions 622-624.

Instructions 622, when executed by the processor 610, cause the processor 610 to modify print data of a virtual build volume including a plurality of 3D objects to be generated through a selective application of a binder agent by a 3D printer, to include a 3D structure at a location within the build volume to protect a 3D object from migrating solvents from the binder agent during a curing operation, the 3D structure to be vertically coinciding and spanning substantially the full horizontal section of the 3D object from the plurality of 3D objects.

Instructions 624, when executed by the processor 610, may cause the processor 610 to cure the respective set of 3D structures during the generation of the build volume.

The above examples may be implemented by hardware, or software in combination with hardware. For example, the various methods, processes and functional modules described herein may be implemented by a physical processor (the term processor is to be implemented broadly to include CPU, SoC, processing module, ASIC, logic module, or programmable gate array, etc.). The processes, methods and functional modules may all be performed by a single processor or split between several processors; reference in this disclosure or the claims to a “processor” should thus be interpreted to mean “at least one processor”. The processes, method and functional modules are implemented as machine-readable instructions executable by at least one processor, hardware logic circuitry of the at least one processor, or a combination thereof.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example of a generic series of equivalent or similar features.

The drawings in the examples of the present disclosure are some examples. It should be noted that some units and functions of the procedure may be combined into one unit or further divided into multiple sub-units. What has been described and illustrated herein is an example of the disclosure along with some of its variations. The terms, descriptions and figures used herein are set forth by way of illustration. Many variations are possible within the scope of the disclosure, which is intended to be defined by the following claims and their equivalents.

What it is claimed is:

1. A computing system comprising a processor to:
access print data of a virtual build volume including a plurality of 3D objects to be generated through a selective application of a binder agent by a 3D printer; and
modify the print data to include a 3D structure at a location within the build volume to protect a 3D object from migrating solvents of the binder agent during a curing operation.

2. The computing system of claim 1, wherein the 3D structure is to be generated through a binder agent or a permeability modifier agent by the 3D printer.

3. The computing system of claim 1, wherein the processor is to modify the print data to include the 3D structure to be vertically coinciding and span substantially the full horizontal section of a 3D object from the plurality of 3D objects.

4. The computing system of claim 2, wherein the processor is to include the 3D structure between a solvent flow generator and the 3D object.

5. The computing system of claim 2, wherein the 3D structure geometry comprises a concave portion facing the 3D object.

6. The computing system of claim 2, wherein the 3D structure is to at least partially encapsulate the 3D object.

7. The computing system of claim 1, wherein the virtual build volume of the accessed print data comprises a first set of the plurality of 3D objects stacked on a respective second set of the plurality of 3D objects, the processor further to:
modify the print data to include a respective set of 3D structures, each of the 3D structures located at a vertically coinciding and between a first 3D object from the first set of 3D objects and a second 3D object from the second set of 3D objects.

8. The computing system of claim 7, wherein the processor is to locate the respective set of 3D structures at horizontally coinciding locations apart from any portion of a 3D object.

9. A method comprising:
modifying print data of a virtual build volume including a plurality of 3D objects to be generated through a selective application of a binder agent by a 3D printer, to include a 3D structure at a location within the build volume to protect a 3D object from migrating solvents from the binder agent during a curing operation;
generating the build volume including the plurality of 3D objects and the 3D structure based on the modified print data; and
curing the build volume.

10. The method of claim 9, wherein the 3D structure is generated by selectively ejecting the binder agent or a permeability modifier agent.

11. The method of claim 10, wherein the permeability modifier agent comprises water and/or ethanol.

12. The method of claim 9, further comprising modifying the print data to include the 3D structure to be vertically coinciding and spanning substantially the full horizontal section of the 3D object from the plurality of 3D objects.

13. The method of claim 12, further comprising modifying the print data to include the 3D structure between a solvent flow generator and the 3D object.

14. The method of claim 9, wherein the virtual build volume comprises a first set of the plurality of 3D objects stacked on a respective second set of the plurality of 3D objects, the method further comprising:
modifying the print data to include a respective set of 3D structures, each of the 3D structures located at a vertically coinciding and between a first 3D object from the first set of 3D objects and a second 3D object from the second set of 3D objects; and
during the generation of the build volume, curing the respective set of 3D structures.

15. A non-transitory machine-readable medium storing instructions executable by a processor, the non-transitory machine-readable medium comprising:
instructions to modify print data of a virtual build volume including a plurality of 3D objects to be generated through a selective application of a binder agent by a 3D printer, to include a 3D structure at a location within the build volume to protect a 3D object from migrating solvents from the binder agent during a curing operation, the 3D structure to be vertically coinciding and spanning substantially the full horizontal section of the 3D object from the plurality of 3D objects; and
generating the build volume including the plurality of 3D objects and the 3D structure based on the modified print data.
